(19) United States
(12) Patent Application Publication
(10) Pub. No.: US 2005/0147037 A1
(43) Pub. Date: Jul. 7, 2005

(54) Scan detection

(75) Inventors: Uriel Maimon, Jerusalem (IL); Alon Kantor, Tel Aviv (IL); Oded Ben Dov, Haifa (IL)

Correspondence Address: DR. MARK FRIEDMAN LTD.;C/o Bill Polkinghorn, 9003 Florin Way, Upper Marlboro, MD, 20772, US

(73) Assignee: Check Point Software Technologies Ltd.

(21) Appl. No.: 11/025,983

(22) Filed: Jan. 3, 2005

Related U.S. Application Data
(60) Provisional application No. 60/534,106, filed on Jan. 5, 2004.

(51) Int. Cl. H04L 1/00

(52) U.S. Cl. 370/230

(57) ABSTRACT

A method for detecting a scan in network connections, each connection to a respective destination determined by a destination key and a destination parameter. For each of the connections, an active-connection entry is logged in a first table. The active-connection entry includes the destination key and the destination parameter. For each destination key entered in the first table, each active-connection entry is counted by: (i) entering in a second table a new-connection entry including the destination key, and (ii) assigning to the new-connection entry a use value; the use value equals a number of the active-connection entries with the destination key. A scan event is generated when the use value exceeds a previously determined new-connection-threshold. If the scan is an “address scan”, the destination key is a destination port and the destination parameter is a destination address (IP); and if the scan is a “port scan” then the destination key is a destination address and the destination parameter is a destination port.

### CROSS REFERENCE TO RELATED APPLICATIONS

This application claims the benefit from U.S. provisional application 60/534,106 filed 5-Jan. 2004.

### FIELD AND BACKGROUND OF THE INVENTION

The present invention relates to network security and, more particularly, to a method for detecting scanning of ports or addresses.

A port is a logical connection and specifically, in Internet protocol TCP/IP or UDP, a client program specifies a particular server (or service) on a computer, e.g. HTTP server, in a network using ports. A TCP/IP or UDP packet has a header that contains a source address, a source port, a destination address and a destination port. The addresses specify the two machines at each end, while the port numbers ensure that the connection between the two computers is uniquely identified. The combination of these four numbers defines a single TCP/IP or UDP connection.

Higher-level applications such as the Web protocol, Hypertext Transfer Protocol, use as destination ports “well-known ports”, numbered 0-1023 that have been assigned by the Internet Assigned Numbers Authority (IANA). Examples of commonly used ports are: 21 for File Transfer Protocol (FTP) services; 25 for Simple Mail Transfer Protocol (SMTP) services and 80 for HTTP services (WWW servers). Ports numbered 1024 to 49151 are registered ports. Examples of registered ports are 1512 for Microsoft Windows Internet Name Service, 1812 for RADIUS authentication protocol. Other application processes are given port numbers 49152-65535 dynamically for each connection.

Port scanning is a reconnaissance technique that a potential attacker uses to discover network services vulnerable to attack. All machines connected to a local area network (LAN) or connected to Internet run many services that listen at ports. By port scanning the attacker finds which ports are available (i.e. being listened to by a service). Typically, a port scan consists of sending a message to each port. The type of response received indicates whether the port is in use and if so, whether the port can be further probed for vulnerability, some information can be deduced just from the fact that no response is generated. Once vulnerabilities are found, a series of attacks are subsequently used to gain unauthorized entry into the network service.

When an attacker is looking for a new host to penetrate, the attacker may begin by looking for vulnerable Internet programs, i.e. “daemons” that have known exploitable problems. Often an attacker performs a “strobe” scan, picking one or more specific ports to search for a specific vulnerability; when doing a strobe scan an attacker may try to probe numerous hosts.

As new vulnerabilities are found the attacker community quickly makes use of the new vulnerabilities to penetrate more hosts. Alternatively, in the case of a port scan, the attacker scans rapidly on all ports of remote machines. If the scan is being done with malicious intent, the attacker generally prefers not to be detected. In order to avoid detection the attacker can attempt spoofing the source IP address or perform a stealth scan. One type of stealth scan simply scans slowly. By scanning slowly, i.e. during a longer period of time, the port scan is less likely to be detected over the usual traffic, however the port scan will require a long time, e.g 24 hours to complete. Other stealth scans are rapidly performed on all ports of remote machines, by setting different TCP flags or by sending different types of TCP packets. One such scan is the SYN or “half-open” scan that partially opens a connection. During a SYN scan, the service is not notified of the incoming connection. A SYN scan determines which ports are listening and which ports are not listening depending on the type of response generated. A FIN scan generates a response from closed ports only; ports that are open and listening do not send a response, and the port scanner will be able to determine which ports are open and which are closed.

Many prior art detection algorithms exist for detecting port or address scanning. One simple algorithm logs the number of packets to different destination ports or address from the same source address within a short period of time. Such an algorithm is ineffective if the attacker is, for instance, spoofing the source IP address. Other algorithms are configured to detect specific scans such as SYN scans, FIN scans and/or ACK scans.

There is thus a need for, and it would be highly advantageous to have a method including a single algorithm useful for detecting general port and/or address scans without relation to the details of particular scan behavior.

### SUMMARY OF THE INVENTION

According to the present invention there is provided a method for detecting a scan in a data network among network connections, each connection to a respective destination, identified by a destination key and a destination parameter. For each of the connections, an active-connection entry is logged in a first table. The active-connection entry includes the destination key and the destination parameter. For each destination key entered in the first table, each active-connection entry is counted by: (i) entering in a second table a new-connection entry including the destination key, and (ii) assigning to the new-connection entry a use value, wherein the use value equals a number of the active-connection entries with the same destination key. A scan event is generated when the use value exceeds a previously determined new-connection-threshold. If the scan is an address scan, the destination key is a destination port and the destination parameter is a destination address (IP); and if the scan is a port scan then the destination key is a destination address and the destination parameter is a destination port. Preferably, an active-connection entry is removed from the first table after a previously determined active-connection-expiry. The active-connection-expiry is a time interval of inactivity for an inactive connection. Preferably, counting is performed only during a previously determined time interval such as by removing the new-connection entry from the second table after a previously determined counter-expiry-interval. The counter expiry interval is a time interval which starts from entering for the first time the new-connection entry in the second table. Preferably, upon generating the scan event, information related to the destination key is erased from the first table. Preferably, the connections are established using data packets, each data packet including a header with the destination key and the destination parameter; the header of the data packet, associated with one of the connections, is read, and the first table is searched for the one connection; and upon completion of the search without finding the one connection listed in the first table, the one connection is entered into the first table. Preferably, the header is read of a first data packet associated with a connection, and the connection is timed. Upon receiving a second data packet associated with the same connection, the timing is reset, the timing indicates a time interval during which the connection is inactive. Preferably when the time interval exceeds a previously determined active-connection-expiry, the active-connection-entry, associated with the connection, is removed from the first table. Each connection is from a respective source including a source address, and preferably the source address is added to either entry. When the scan event originates from an attacking source address, communications are preferably blocked from the attacking source address. Preferably an entry either the active-connection entry and/or the new-connection entry includes a type parameter indicating a connection type such as SYN, FIN, ACK and XMAS.

According to the present invention there is provided a system, for detecting in a data network a scan among network connections to a respective destination identified by a destination key and a destination parameter. The system includes a processor which for each of the connections logs an active-connection entry in a first table. The active-connection entry includes the destination key and the destination parameter. The system further includes a memory which stores the first table. For each destination key entered in the first table, the processor counts each active-connection entry, and enters in a second table stored in the memory a new-connection entry including the destination key and a use value; the use value is a number of the active-connection entries with the destination key. The system further includes a mechanism which generates a scan event when the use value exceeds a previously determined new-connection-threshold.

According to the present invention, there is provided a program storage device readable by a machine, tangibly embodying a program of instructions executable by the machine to perform a method for detecting a scan among a plurality of connections, according to the methods described herein.

According to the present invention there is provided a method for detecting a scan in a data network among network connections, each connection to a respective destination, identified by a destination key and a destination parameter. For each of the connections, an active-connection entry is logged. The active-connection entry includes the destination key and the destination parameter. For each destination key entered, each active-connection entry is counted by: (i) entering in a second table a new-connection entry including the destination key, and (ii) assigning to the new-connection entry a use value, wherein the use value equals a number of the active-connection entries with the same destination key. A scan event is generated when the use value exceeds a previously determined new-connection-threshold.

### BRIEF DESCRIPTION OF THE DRAWINGS

The invention is herein described, by way of example only, with reference to the accompanying drawings, wherein:

FIG. 1 (prior art) is a drawing of a conventional network showing a gateway in which the scan detection mechanism of the present invention is implemented;

FIG. 2 (prior art) is a drawing according to an embodiment of the present invention of a gateway computer;

FIG. 3 is a drawing showing data structures, according to an embodiment of the present invention; and

FIG. 4 is a flow diagram of a method for port scan detection, according to an embodiment of the present invention.

### DESCRIPTION OF THE PREFERRED EMBODIMENTS

The present invention is of a system and method for providing network security, specifically a system and method for detecting computer resource scans particularly port and/or address scans. The principles and operation of a system and method for scan detection, according to the present invention, may be better understood with reference to the drawings and the accompanying description.

It should be noted, that although the discussion herein relates to scan detection at a gateway between a local area network (LAN) and a wide area network (WAN), the present invention may, by non-limiting example, alternatively be configured internally within a single network, e.g. LAN. It should be noted that the present invention may be adapted to any type of network, within a local area network, within wide area network, a virtual private network, or between different network types. Furthermore, the present invention includes embodiments implemented in “sniffer” mode. Other embodiments include implementation in network components such as a switch, router or bridge.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, the principal intention of the present invention is to provide a mechanism for scan detection using time-based heuristics of access to ports or address. The scan detection mechanism of the present invention is not limited, therefore, to the detection of specific scans such as full connection scans, SYN scans, FIN scans, ACK scans and/or XMAS scans and is capable of detecting a very broad spectrum of currently known and future port scans. Furthermore, the present invention is intended to operate in real time and on large amount of network traffic, for instance by running in the kernel of an operating system allowing corrective action to be taken in real time and without switching context from kernel to application space of the operating system. A network connection is defined by multiple parameters, typically including source parameters, e.g. src, sport and destination parameters e.g. dst, dport. According to the an embodiment of the present invention, connections are counted based on a “key”. The term “key” as defined herein refers to one or more of the parameters defining the network connection. The term “destination key” is defined herein to include at least in part a destination parameter. The term “table” as used herein refers to all data structures including hashes, and binary trees.

Embodiments of the present invention are described using two tables stored in memory, a “first table” and a “second table”. The present invention may be equivalently implemented using a single structured table. Specifically, “first table” and “second table” as used herein can be equivalently implemented as a single structured table in which the same key value from both tables is stored once.

It should be noted that while the discussion herein is directed to primarily to port scan detection on a single host the principles of the present invention are similarly implemented for detecting scans of multiple hosts on the same port, i.e. address (IP) scans. Moreover, while the discussion herein is directed to scan detection in the framework of TCP/IP protocol the principles of the present invention may be adapted for use in, and provide benefit for other protocols, e.g. UDP, ICMP and/or IGMP.

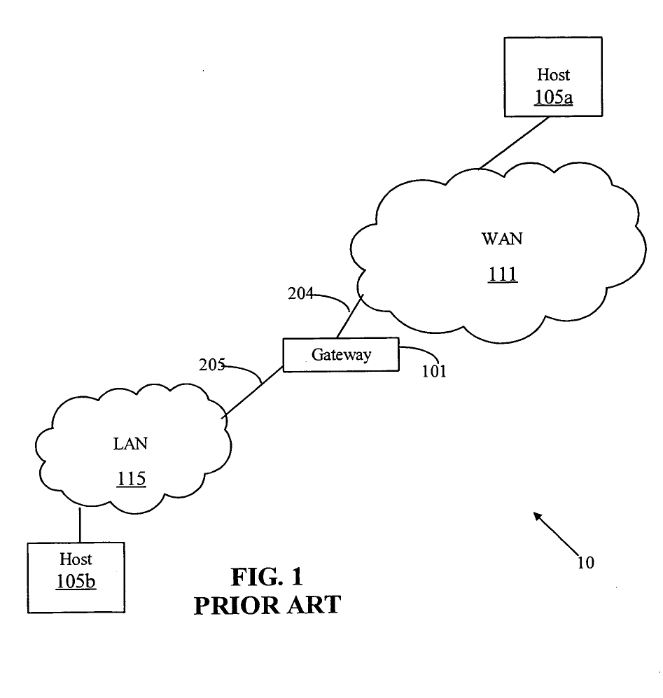

Reference is now made to FIG. 1 (prior art) showing a simplified prior art data network 10 including a first network zone e.g. wide area network (WAN) 111 attached to a second network zone e.g. local area network (LAN) 115 through a gateway 101. Host computer 105a, is attached to WAN 111. Host computer 105b is attached to LAN 115. Host 105a conventionally establishes a connection, e.g. TCP/IP with host 105b by sending data packets to host 105b including in the headers of the data packets a source address (src) e.g. IP address of host 105a, a source port (sport), a destination address (dst), e.g. IP address of host 105b and a destination port (dport) e.g. 21 for FTP service. If host 105a has malicious intent, host 105a initiates a port scan on LAN 115 designating for instance all hosts, e.g. 105b and/or all ports (0-65,535). Alternatively, host 105b is running an application infected with a worm performing an IP scan to find vulnerable IP addresses for the worm to self-replicate.

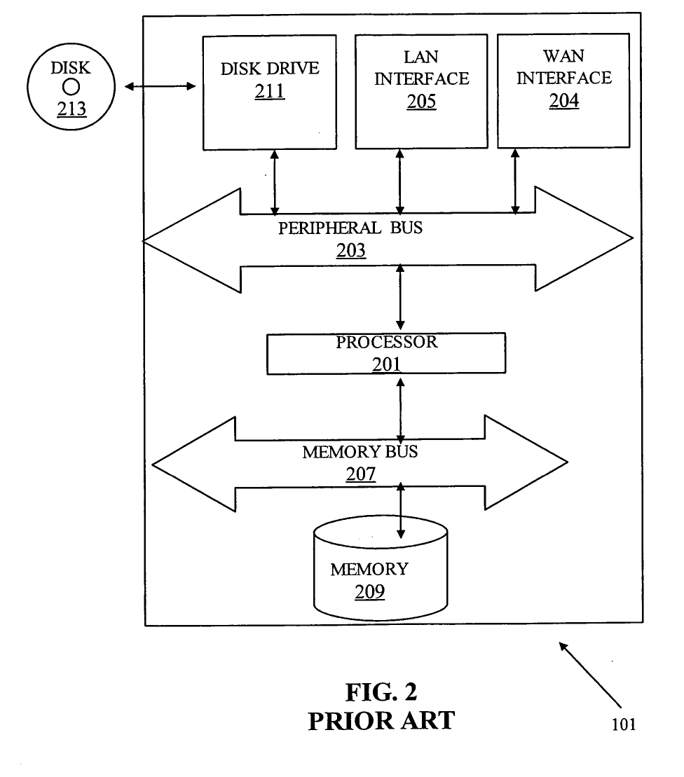

In the configuration shown in data network 10, all connections into LAN 115 are routed through gateway 101. An embodiment of the present invention for port scan detection includes an application running on gateway 101. Reference is now made to FIG. 2 which illustrates a computer, for instance gateway 101. Gateway 101, includes a processor 201, a storage mechanism including a memory bus 207 to store information in memory 209 and a WAN interface 204 and LAN interface 205, each operatively connected to processor 201 with a peripheral bus 203. Gateway 101 further includes a data input mechanism 211, e.g. disk drive from a program storage device 213, e.g optical disk. Data input mechanism 211 is operatively connected to processor 201 with a peripheral bus 203.

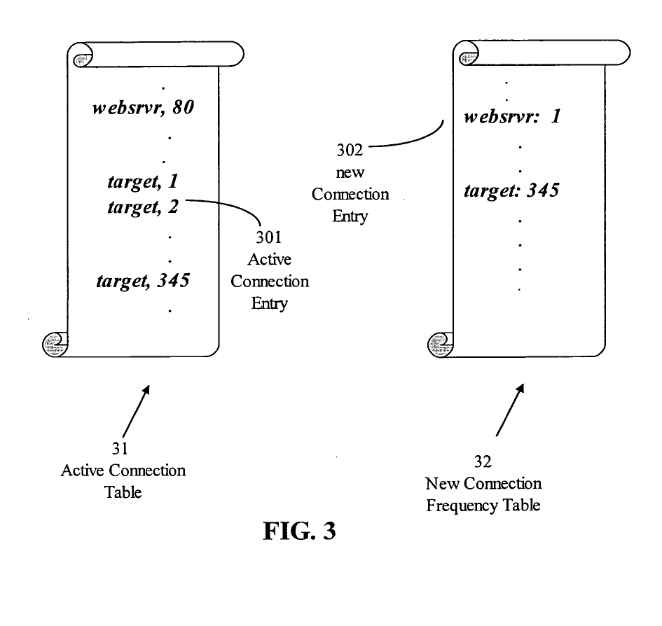

Gateway 101, preferably using processor 201, monitors connections identified by a parameters e.g. (src, sport, dst, dport) routed through gateway 101. Referring now to FIG. 3, a port scan detection method, according to an embodiment of the present invention uses two tables, i.e. data structures in memory 209, an active-connection table 31 and a new-connection-frequency table 32. The term “new” such as in “new” connections is defined herein to include “updated” connections. Active-connection table 31 includes multiple active-connection entries 301, for each connection e.g. the connection between host 105a and host 105b. Each active-connection entry 301 includes two parameters describing the connection: destination address (dst) and destination port (dport). By way of example, active-connection table 31 includes an entry (dst, dport)=(websrvr, 80), an http connection to a Web server behind gateway 101. In the example, active-connection table 31 further includes entries:
(dst, dport)=(target, 1), (target, 2) . . . (target, 345)
   a total of 345 connections to ports 1 through 345 to destination target, e.g. P address of host 105b.

New-connection-frequency table 32 includes new-connection entries 302, each entry 302 including a key to the entry dst, e.g. destination IP address, and a use value, the total number of connections with destination ports associated with the destination IP address dst. One entry 302 (dst: use value) is (websrvr: 1) indicating that websrvr has one port in use. Another entry 302 in new-connection frequency table 32 is (target, 345) indicating the 345 ports in use of target, e.g. host 105b.

Typically, if the connection is no longer active during a previously determined time interval hereinafter referred to as “active-connection expiry”, active-connection entry 301 is removed from active-connection table 31. Similarly, new-connection entry 302 is removed from new-connection-frequency table 32 after a previously determined “counter expiry interval” from the creation of the entry 302, i.e. a time period during which a destination address receives no additional new connections. It should be noted that the “counter expiry interval” may be short compared to “active connection expiry” and therefore the value stored in table 32 may be smaller than the number of relevant connections in table 31, only connections that where started in a short period of time are counted.

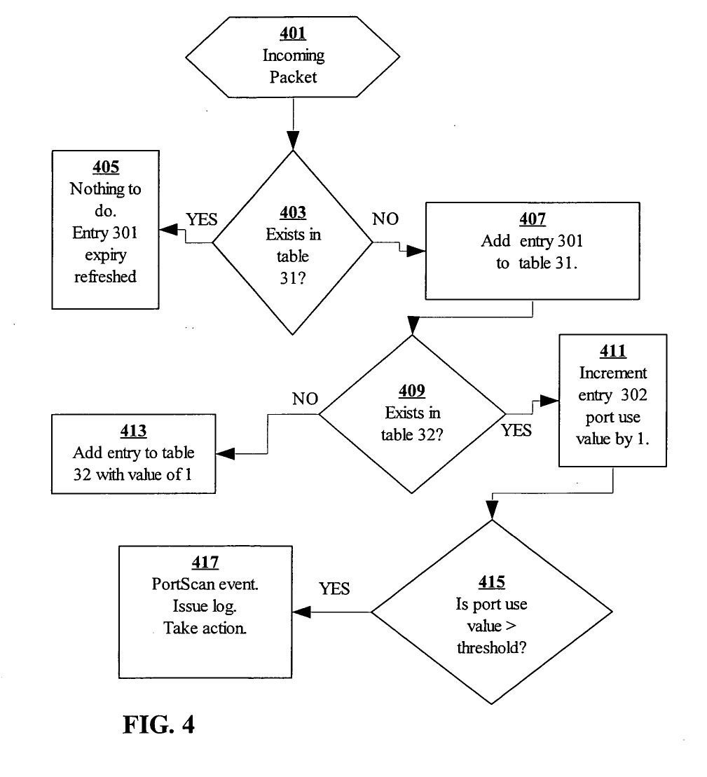

Reference is now made to FIG. 4, a flow diagram illustrating logically the operation of an embodiment of the present invention. An incoming data packet is monitored and connection information (dst, dport) is retrieved (step 401). If the connection already exists in active-connection table 31 (decision block 403) then only the “active-connection expiry” is reset (step 405) for the connection. If the connection does not exist (decision block 403) then new-connection entry 301 is added to active connection table 31. In case of a new connection, if the destination of the connection (dst) doesn't exist in table 32 (decision block 409) then entry 302 with a key of (dst) and a port use value of one is added to table 32. Otherwise, if the destination of the connection already exists in table 32, (decision block 409) then in entry 302, the port use value is incremented by one. If the port use value exceeds (decision block 415) a previously determined “new-connection threshold” then a port scan event is generated, the port scan event is typically logged and preventative action is taken. After the port scan event is generated information, including entries 301 and 302 related to the port scan event is preferably erased from tables 31 and/or 32 from free memory 209.

A simple example is as follows:
“active connection expiry”=5 minutes
“counter expiry interval”=30 seconds
“new connection threshold”=100 connections
   With these parameters, a port scan event is generated when 100 packets arrive at 100 distinct ports within 30 seconds. In a preferred embodiment of the present invention, by using a relatively short counter-expiry-interval the use value is compared directly against a new-connection-threshold without directly computing a rate of increase of new connections with the same key.

In other embodiments of the present invention, entry 301 in table 31 and/or entry 302 in table 32 further include a source address (src). In either case, the source address can be used as an additional parameter as a basis for counting new connections, thus making the counting more granular and increasing the sensitivity of the detection. The source address is preferably used to keep a record of which address is involved in the the scan making detection more specific. In some embodiments, a counter for different source addresses is added similar to the counter for different port parameter values. Source information is used for instance to decrease the rate of false positive port scan events. When “new connection threshold is reached and a port scan event is generated, then source address information is preferably used to take appropriate action for instance blocking communications from attacking host 105b based on the source address of 105b. Furthermore, a “type parameter” may be added to entries 301 and/or 302 indicating packet type. For instance a SYN packet is type 1, a FIN packet is type 2, ACK packet is type 3, XMAS packet is type 4 etc. When source and/or type parameters are included in entry 301, these parameters may be used in addition to a destination parameter (e.g. dst) as part of a key for counting connections.

Other embodiments of the present invention include address e.g. IP, scans in which the roles of “destination port” and “destination address” are reversed. Entry 302 in table 32 use “destination port” as the key and “destination addresses” are counted. An “address use value” is the number of new connections with the same destination port. It is therefore appreciated that port scans and IP address scans are included equivalently in the scope of the present invention.

Therefore, the foregoing is considered as illustrative only of the principles of the invention. Further, since numerous modifications and changes will readily occur to those skilled in the art, it is not desired to limit the invention to the exact design and operation shown and described, and accordingly, all suitable modifications and equivalents may be resorted to, falling within the scope of the invention.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

1. A method for detecting a scan in a data network among a plurality of network connections, each connection to a respective destination, the method comprising the steps of:
wherein the respective destination is identified by a destination key and a destination parameter,
(a) for each of the connections, logging an active-connection entry in a first table, said active-connection entry including the destination key and the destination parameter;
(b) for each destination key entered in said first table, counting each active-connection entry by:
(i) entering in a second table a new-connection entry including said destination key, and
(ii) assigning to said new-connection entry a use value, wherein said use value equals a number of said active-connection entries with said destination key; and
(c) generating a scan event indicating the detecting when said use value exceeds a previously determined new-connection-threshold.

2. The method, according to claim 1, wherein the destination key is includes a destination port and the destination parameter includes a destination address.

3. The method, according to claim 1, wherein the destination key includes a destination address and the destination parameter includes a destination port.

4. The method, according to claim 1, further comprising the step of:
(d) removing at least one said active-connection entry from said first table after a previously determined active-connection-expiry, whereby said active-connection-expiry is a time interval of inactivity for an inactive connection among the connections.

5. The method, according to claim 1, wherein said counting is performed during a previously determined time interval.

6. The method, according to claim 1, further comprising the step of:
(d) removing said new-connection entry from said second table after a previously determined counter-expiry-interval, wherein said counter expiry interval is a time interval starting from said entering said new connection entry.

7. The method, according to claim 1, further comprising the step of:
(d) upon said generating said scan event, erasing all information related to the destination key from said first table.

8. The method, according to claim 1, wherein said connections are established using at least one data packet, said at least one data packet including a header with the destination key and the destination parameter, further comprising the steps of:
(d) reading the header of said at least one data packet associated with one of the connections;
(e) searching said first table for said one connection; and
(f) upon completion of said searching without finding said one connection listed in said first table, entering said one connection to said first table.

9. The method, according to claim 1, wherein said connections use a plurality of data packets, said data packets including a header with the destination key and the destination parameter, further comprising the steps of:
(d) upon reading the header of a first said data packet associated with a first said connection, timing said first connection;
wherein said timing indicates a time interval during which said first connection is inactive.

10. The method, according to claim 9, further comprising the step of:
(e) upon receiving a second said data packet associated with said first connection, resetting said timing.

11. The method, according to claim 9, wherein said time interval exceeds a previously determined active-connection-expiry, further comprising the step of:
(f) removing said active-connection entry, associated with said connection, from said first table.

12. The method, according to claim 1, wherein said each connection is from a respective source including a source address, wherein at least one entry includes said source address, wherein said at least one entry is selected from the group consisting of said active-connection entry and said new-connection entry.

13. The method, according to claim 12, wherein said scan event originates from at least one attacking source address, further comprising the step of:
(d) blocking communications from at least one said attacking source address.

14. The method, according to claim 1, wherein at least one data entry further includes a type parameter indicating a connection type, wherein said at least one data entry is selected from the group of said active-connection entry and said new-connection entry

15. The method, according to claim 14, wherein said connection type is selected from the group consisting of SYN, FIN, ACK and XMAS.

16. A system for detecting a scan in a data network among a plurality of network connections, each connection to a respective destination with is identified by a destination key and a destination parameter, the system comprising:
(a) a processor which for each of the connections, logs an active-connection entry in a first table, said active-connection entry including the destination key and the destination parameter;
(b) a memory which stores said first table;
wherein for each destination key entered in said first table, said processor counts each active-connection entry, thereby entering in a second table stored in said memory, a new-connection entry including said destination key and a use value, wherein said use value equals a number of said active-connection entries with said destination key; and
(c) a mechanism which generates a scan event when a said use value exceeds a previously determined new-connection-threshold.

17. A program storage device readable by a machine, tangibly embodying a program of instructions executable by the machine to perform a method for detecting a scan among a plurality of connections, each connection to a respective destination identified by a destination key and a destination parameter, the method comprising the steps of:
(a) for each of the connections, logging an active-connection entry, said active-connection entry including the destination key and the destination parameter;
(b) for each destination key entered, counting each active-connection entry by:
(i) entering a new-connection entry including said destination key, and
(ii) assigning to said new-connection entry a use value, wherein said use value equals a number of said active-connection entries with said destination key; and
(c) generating a scan event indicating the detecting when a said use value exceeds a previously determined new-connection-threshold.

18. A method for detecting a scan in a data network among a plurality of network connections, each connection to a respective destination, the method comprising the steps of:
wherein the respective destination is identified by a destination key and a destination parameter,
(a) for each of the connections, logging an active-connection entry, said active-connection entry including the destination key and the destination parameter;
(b) for each destination key entered, counting each active-connection entry by:
(i) entering a new-connection entry including said destination key, and
(ii) assigning to said new-connection entry a use value, wherein said use value equals a number of said active-connection entries with said destination key; and
(c) generating a scan event indicating the detecting when said use value exceeds a previously determined new-connection-threshold.
